(19) United States
(12) Patent Application Publication
(10) Pub. No.: US 2020/0000118 A1
(43) Pub. Date: Jan. 2, 2020

(54) FORMULATION FOR THE PRODUCTION OF COTTON CANDY WITHOUT SUCROSE

(71) Applicant: ZUKARA S.A. DE C.V.

(72) Inventor: Julián Ernesto Real Angulo, Tultitlán Edo (MX)

(73) Assignee: ZUKARA S.A. DE C.V., CIUDAD (MX)

(21) Appl. No.: 15/739,103

(22) PCT Filed: Jul. 20, 2017
(86) PCT No.: PCT/MX2017/000082

§ 371 Date: Dec. 21, 2017

(30) Foreign Application Priority Data
Aug. 5, 2016 (MX) 2016/010239

(51) Int. Cl. A23G 3/38; A23L 33/26; A23G 3/34; A23G 3/42; A23G 3/48; A23L 29/294

(52) U.S. Cl. CPC A23G 3/38; A23L 33/26; A23G 3/0051; A23G 2210/00; A23G 3/48; A23L 29/294; A23G 3/42

(57) ABSTRACT

The present invention is related with the manufacturing industry of raw materials for the production of sweet candies. More specifically, it's related with the manufacturing of raw materials that usually includes sucrose in its composition and more specifically with the manufacturing of raw material for the production of cotton candy. The formulation has the advantage of not containing sucrose and allowing the manufacturing of cotton candy. It may be processed in a normal cotton candy production machine and with an equal performance of that obtained when sucrose is used; its components doesn't result in glucose neither by digestion nor by metabolism. This formulation has the following base qualitative composition.
Steviol glycosides or Stevia rebaudiana extract.
Poly-dextrose.
Isomaltose.
Isomaltulose.
Glucono-deltalactone.
Silicon Dioxide.

### FIELD OF INVENTION

The present invention is related to the manufacturing industry of raw materials for sweet candies. More specifically it is related with the manufacturing of raw materials that usually includes sucrose in its composition and more specifically with the manufacturing of raw material for the production of cotton candy.

### BACKGROUND OF THE INVENTION

The normal or current powder mixtures with which cotton candies are made only contains granulated sucrose and artificial colorings. The sucrose contributes with the total energy content in the cotton candy; assuming that one portion of cotton candy contains 30 grams of sucrose, set portion contributes with 120 kilocalories. The high-glycemic content of the resulting product limits its consumption for persons with diabetes, hypertension or cardiovascular diseases.

The great majority of the artificial colorings used in these products are related with the generation of cancerous cells and the stimulation of certain allergic symptoms. A great advantage that this simple sucrose formula offers is its great flavor stability through the severe thermal treatment that the mixture is subjected to in the cotton candy forming machine, as well as the high malleability level of the product once it's melted for it to be sprayed and the cotton is formed with the sufficient volume in order to obtain a product with a good appearance and stability, characteristics that were difficult to equalize with the formulation without sugar sweetened with sweeteners that does not contribute with calories.

It's very obvious when it's intended to substitute sucrose in a composition to think in sweeteners such as saccharin, aspartame and sucralose. Although also the cyclamate and the herbal sweetener stevia. However in the case of, a composition for the, production of cotton candy in which the sucrose sugar in addition to its sweetening and flavoring powers, further confers the structure of the product. This change is not easy.

The cotton candy is produced by first smelting the sucrose and forming by centrifugation a set of fine threads, passing the melted sugar through a series of tiny orifices. These threads will form the cotton candy.

If the sucrose is substituted by another sweetener, these replaces the sweetening function of the sucrose, nevertheless this other sweetener will hardly achieve to form the fibers that constitutes the cotton. In other words neither saccharin, aspartame, sucralose, nor the cyclamate or the herbal sweetener stevia will have the behavior that allows the sugar to form fibers (threads) and therefore the sucrose substitution is made more complex.

Hence, here is a hard to break paradigm, since the sucrose substitution would require finding a product that has the same behaviors as sucrose, such as its sweetening power, its capacity to, melt at a given temperature, the capacity to form threads more or less resistant, in the caramel flavor that it generates when its melted, in its capacity of being stored without becoming compacted, etc.

With the awareness of the harmful effects that large intakes of digestible glucose causes, at this time it has been detected the need to substitute the sucrose or any other polysaccharide, disaccharide or monosaccharide with the capability of releasing glucose when digested in the digestive tract as is the case of starch; or of being transformed in glucose by the metabolism as is the case of the fructose or galactose.

### OBJECTIVES OF THE INVENTION

One of the objectives of the present invention is to achieve a composition without sucrose that would allow the manufacturing of cotton candy.

Another of the objectives is that such composition may be processed in a normal cotton candy production machine with an equal performance as achieved when sucrose is used.

Still another objective, apart from substituting the sucrose is that the components that embed the composition won't result in glucose, neither by digestion nor by metabolism.

Yet another objective is to achieve a composition that will not absorb water nor get clumped during its storage after the manufacturing of this composition of raw material.

And all those advantages and objectives that will become apparent with the reading of the present description followed of the examples that are enclosed for illustrative but not limited purposes, as an integral part of the description mentioned.

### BRIEF DESCRIPTION OF THE INVENTION

One of the first challenges that we've faced for the attainment of a composition that did not contained sugar for the manufacturing of cotton candy was finding an edible compound, that had a low glucose assimilation when ingested, but with the capability of melting without losing its nature, so that with centrifugation threads are formed and altogether will form the sweet known as cotton candy.

Several dietary vehicles were tested such as dextrose, poly-dextrose, malto-dextrin, isomaltose, isomaltulose and inulin. Surprisingly the only one that got ahead was the poly-dextrose because all the other vehicles got clumped in the cotton thread forming device, or the threads became compacted once formed, when they came into contact with each other, changing the consistency of the cotton.

This was surprising since it was never considered that poly-dextrose could be melted. The poly-dextrose is sugar starch and fat substitute with low caloric value (approximately 1 kcal/g) and it produces a similar effect from the soluble dietary fibers, besides it offers health benefits as a probiotic. As a substitute of sugar, the poly-dextrose improves the texture and flavor of the products, but it must be used with other sweeteners, thus it doesn't provide a sweet flavor.

The poly-dextrose also presents a wide range of application in food products and it may be used in baking products as well as confectionery and chocolates, candies in general, cereal bars, beverages, etc. but never up to now had it been required to melt and form fibers or threads for the manufacturing of cotton candy.

Besides the poly-dextrose is a soluble fiber of 1 kcal per gram and it is obtained from the polymerization of glucose, sorbitol and organic acid (Citric, Fumaric, Stearic, etc.). It is highly ramified with every glycosidic linkage possible and it has a DP (Average Length) of 12. The poly-dextrose is not digested in the small intestine, but it's partially fermented in the large intestine. This turns out in various health benefits, including the growth of beneficial bacterias (probiotics), softening the fecal waste, lesser PH, production of SOFA (facilitation of the evacuation), attenuation of the blood glucose and the increase of the calcium absorption.

The granulometry of the powder mixture in general is important for two reasons:

FIRST: A thick granulometry or granulated will allow that the process of the cotton candy is performed in such way that the solids melt, are sprayed and cotton candy threads are formed, in such rhythm that the cotton candy structure is built with the proper and characteristic volume of the product, furthermore of a good stability of the cotton candy structure once formed and high performances: otherwise if the powder mixture is too thin, this results would not be obtained.

SECOND: There is a limit in the granulometry of the mixture. If the powder mixture is too, thick it will not be uniform, considering there are other ingredients that will take part in the formulation as natural flavoring and coloring powders that are added in fairly small portions, but that must spread out perfectly in all the mixture so that a consistent product with good results is always obtained, which is not possible to perform if the mixture's granulometry is too thick, which provokes a separation of these ingredients that usually are thinner.

### DETAILED DESCRIPTION OF THE INVENTION

The qualitative composition for the manufacturing of cotton candy without sucrose is formed by the following compounds:
Steviol glycosides or stevia rebaudiana extract.
Poly-dextrose.
Isomaltose.
Isomaltulose.
Glucono-deltalactone and
Silicon dioxide

These compounds have the following functions in the composition:
A. Steviol glycosides or stevia rebaudiana extract: Is the asset that contributes with the main sweetness to the product without sugar's caloric content.
B. Poly-dextrose: Is the vehicle o main carrier in the formulation of the product. It has the function of a soluble fiber helping in the absorption and digestion of the product.
C. Isomaltose: Its main function is to contribute with an acceptable granulometry to the powder mixture in order to promote and regulate the crystallization of the ingredients during the candy (cotton candy) formation process. Its caloric contribution in the product is much lower than the one from sucrose.
D. Isomaltulose: Controls the crystallization of the mixture after it's melted and dispersed in the cotton forming machine thus the characteristic fibers are obtained. This similarity with sucrose allows that the cotton candy provides the satiety signals to the consumer's gustatory system. It contributes with the same calories as sucrose, but its glucose content is much lower.
E. Glucono-deltalactone: It contributes enhancing the sweetness of the product without a caloric input; it helps the conservation of the cotton candy once formed.
F. Silicon dioxide: It has a function of avoiding the humidification of the poly-dextrose, since the poly-dextrose is a highly hydrophilic compound.

The quantitative composition would be:
A. Steviol glycosides or stevia rebaudiana extract: Between 0.3% and 0.5%
B. Poly-dextrose: Between 37% and 58%.
C. Isomaltose: Between 16% and 30%.
D. Isomaltulose: Between 16% and 30%
E. Glucono-deltalactone: Between 0.8% to 1.20%.
F. Silicon dioxide: Between 0.2% to 0.8%

Leaving this quantitative composition:
The characteristic form, appearance and texture of cotton candy will not be obtained.
The product's flavor won't be sweet.
It is obtained a product with a bitter trace that is unacceptable.
It is obtained a beige or significantly brown cotton candy instead of the typical white cotton candy.
It's obtained a cotton candy texture doesn't keep up or sustain the characteristic shape long enough for its consumption.
The powder mixture of the product could agglomerate too much during the storage for its use, mostly in damp locations.

La Glucono-deltalactone helps to increase the sweet flavor profile of the stevia. With this the bitter trace that may appear because of the effect of the stevia is diminished or regulated.

On its own, the Poly-dextrose doesn't have the proper physical properties (melting crystallization point) for the attainment of cotton candy. The isomaltose helps so that the poly-dextrose acquires these characteristics in the cotton machine with the real operation temperatures and thus obtaining the cotton candy with the desired appearance and texture characteristics.

The following tests had to be carried out to achieve the obtained composition:

Sensory evaluation of different addition levels of Stevia to determine the most appropriate sweet flavor profile for the desired product. Hedonic scale application for the evaluation of the samples, and the statistic analysis of the results.

Separate analysis of the melting point and the crystallization temperatures of different raw materials, in order to select the most appropriate to take part in the mixture, accordingly with the operation conditions of the commercial cotton machines.

Testing on several formulations with different use levels of the selected compounds for the manufacturing of cotton candy in the cotton machine in order to evaluate the characteristics of the attained product; and based on these results fixate the base formulation for the powder mixture.

Additionally it's necessary to indicate that the granulometry is important for the behavior of the mixture and of the manufactured cotton. The granulometry of the mixture is mainly given by the isomaltose, combined in precise quantities with isomaltulose and poly-dextrose in order to provide with the proper granulometry for the cotton candy attainment, and to obtain a uniform powder mixture free of clumps during its storage and shelf life. The granulometries of the different compounds that integrates the powder mixture formulation Stevien for cotton candy are the following:

For the rebaudioside, natural powder colorings, natural powder flavorings and silicon dioxide, the particle size ranges are between 0.2 and 0.5 mm.

For the isomaltulose, Glucono-deltalactone, citric acid and ascorbic acid, the particle size ranges are between 0.71 and 0.8 mm.

For the poly-dextrose and de isomaltose the particle size ranges are between 1.25 and 3.5 mm.

With this particle size distribution it's guaranteed that the formulation is functional for the attainment of cotton candy in any cotton machine, with good volume and stability characteristics in the structure of the cotton; that the mixing of the different ingredients that integrates the product during the manufacturing process is uniform with no significant separation of phases; and that the powder mixture doesn't form lumps during the storage.

### EXAMPLES

### Example 1

### Formulation to Avoid Clumping

Poly-dextrose, dextrose, stevia and silicon dioxide were included as ingredients of the formulation; four formulations were used in which the levels of poly-dextrose and dextrose were modified while the other two ingredients remained in the same quantity in the 4 formulations, being the poly-dextrose the most hygroscopic ingredient that would integrate the formulation. The four generated samples were packed in low density polyethylene transparent bags, lined with Kraft paper bags (simulating the packaging material that is going to be used to pack the product); and incubated for 45 days at 42° C. with relatively high humidity.

Once finished the incubation the samples were checked and none of them presented clumping of the product, which is why it's deduced that the silicon dioxide levels used in each formulation is sufficient to avoid dumping regardless of the greater or lesser quantity added of poly-dextrose, even though it may be that the granulometry of the added dextrose also contributes to spread enough the poly-dextrose to avoid it to clump with the pass of time.

As a preliminary result of this stage the samples were tasted in order to know the sweetness level they presented and it was found a sweet flavor too intense and with an excessive level of bitterness, thereby is concluded that the level of Stevia added in each formulation is overmuch for the sweet flavor profile desired.

### Example 2

### To Find the Best Sweetness Level

There were made 4 formulations with Poly-dextrose, stevia and silicon dioxide; and applying different amounts of Stevia in each one of the 4 formulations. With this test it was found the actual amount of Stevia that integrates the actual Base Formula and that with this formula it is possible to obtain the sweetness level and the sweet flavor profile of the cotton candy.

In the same stage of testing it is raised the experimentation with 4 different formulas with different quantities of silicon dioxide, in order to find the minimum amount required from this ingredient to be added in the formula to avoid the powder mixture clumping. It was also added to each applied formulation the same amount of Glucono-deltalactone with the objective of verifying if this ingredient may improve the sweet flavor profile in the powder mixture.

The four generated samples were packed in low density polyethylene transparent bags, lined with Kraft paper bags (simulating the packaging material that will be used to pack the product); and incubated for 20 days at 42° C. and a relatively high humidity.

### Example 3

### Testing in Cotton Machine

The results obtained with the previous compositions were not very favorable since it was obtained a very scarce cotton candy, not very bulky; and there were attained many residues and wastes. After several tests trying to form the cotton candy with sucrose, poly-dextrose and dextrose individually it was concluded that the dextrose generates a very heavy liquid that carries out with the majority of the solids in the bottom of the trey in the cotton machine, avoiding them to spread with the sprinkler disc of the cotton machine and forming a good amount of thread to form the cotton.

With the attained results is raised an experimental protocol to evaluate the melting points and the characteristics of the crystallization of different solids that could play a part in the base formula.

### Example 4

### Study of the Melting Points and the Crystallization of Probable Compounds of the Formulation

The ingredients considered and evaluated are sucrose, dextrose, poly-dextrose, maltodextrin, isomaltose and isomaltulose. Detailed notes were taken of the melting temperatures that were reached by each compound individually, the crystallization point when cooling down and the physical characteristics of the attained crystals with each one of the ingredients. After the application of this experimental protocol it's deduced that both dextrose and maltodextrin shouldn't be integrated to the base formula of the product, since their melting and crystallizing characteristics aren't consistent with the process and the conditions of the cotton candy formation.

With the results obtained in this experimental stage it's concluded that the ingredients that may take part in the base formula of the Stevien powder mixture for cotton candy are: poly-dextrose, isomaltose and isomaltulose to among which it'll be added the Stevia, the Glucono-deltalactone and the silicon dioxide in the addition levels found in the previous experimental stages.

### Example 5

### Definition of the Final Composition

There are two different formulation tested to be applied in the cotton machine and form cotton candy. In the first formulation it was included a mixture of the following ingredients: Sucrose—Poly-dextrose—Isomaltose—Isomaltulose; and in the second formulation it was included a mixture of the following ingredients: Poly-dextrose—Isomaltose—Isomaltulose; each mixtures includes Stevia, Glucono-deltalactone and Silicon dioxide in the amounts found in the previous experimental stages. The samples generated with each formulation were tested in the same quantities in the cotton machine and under the same temperature conditions. The results attained in this the fifth experimentation stage conclude that the base formula for the Stevien powder mixture for cotton candy is; Poly-dextrose, Isomaltose, Isomaltulose, Stevia, Glucono-deltalactone and Silicon Dioxide.

With this formulation it can be obtained a cotton candy sufficiently voluminous to cover the appearance requirements of the product; the level of sweet flavor on the product is excellent, with an acceptable sweet flavor profile; without the necessity of including sucrose in the formulation, and with this to accomplish the diminish of the caloric load of the final product, just as a cero glycemic index. It was even possible to detect with this test that the inclusion of sucrose in the formulation provokes the attainment of a less voluminous cotton candy, less firm to the touch and less stable

The invention has been sufficiently describes so that a person with medium knowledge in the subject may reproduce and obtain the results mentioned in the present invention. However any skillful person in the field of technology that belongs to the present invention may be able of making non described modifications in a determined composition or in its manufacturing process, it's required from the requested matter in the following claims, such structures should be comprehended within the scope of the invention.

Having described the invention, it's considered as an innovation and therefore is claimed as property the contents of the following claims.

1. Formulation for the production of cotton sugar without sucrose, characterized by having the following qualitative composition:
Steviol glycosides or Stevia rebaudiana extract.
Poly-dextrose.
Isomaltose.

2. Formulation for the production of cotton candy without sucrose characterized furthermore because the qualitative composition also comprehends
Glucono-deltalactone
Isomaltulose y
Silicon dioxide

3. Formulation for the production of cotton candy without sucrose, as demanded in claim 1, characterized furthermore for having the following quantitative composition:
A. Steviol glycosides or Stevia rebaudiana extract: Between 0.3% and 0.5%
B. Poly-dextrose: Between 37% and 58%.
C. Isomaltose: Between 16% and 30%.

4. Formulation for the production of cotton candy without sucrose, as demanded in claim 2, characterized furthermore because:
The Isomaltulose is found between 16% and 30% regarding the total composition.
The Glucono-deltalactone: is found between 0.8% and 1.20%.
The Silicon dioxide is found between 0.4% and 0.8%.

5. Formulation for the production of cotton candy without sucrose, as demanded in claim 1, characterized furthermore because the compounds have the following granulometry:
The rebaudioside, the natural powder colorings, the natural powder flavorings and the Silicon dioxide between 0.2 and 0.5 mm;
The Isomaltulose, the Glucono-deltalactone, the citric acid and ascorbic acid between 0.71 and 0.8 mm;
The Poly-dextrose and the Isomaltose between 1.25 and 3.5 mm.
